(19) United States
(12) Patent Application Publication
(10) Pub. No.: US 2017/0131159 A1
(43) Pub. Date: May 11, 2017

(54) METHODS OF ANALYZING PRESSURE DISTRIBUTION ROW BY ROW

(71) Applicant: NATIONAL TAIWAN UNIVERSITY HOSPITAL, Taipei City (TW)

(72) Inventor: Wei-Li HSI, Taipei City (TW)

(21) Appl. No.: 15/147,185

(22) Filed: May 5, 2016

(30) Foreign Application Priority Data
Nov. 5, 2015 (TW) 104136535

(51) Int. Cl. G01L 1/00

(52) U.S. Cl. CPC G01L 1/005

(57) ABSTRACT

The present invention provides a method of calculating an average moment arm row by row, comprising measuring the pressure an object exerts on a pressure sensor matrix, obtaining the pressure values and moment arms for each sensor of the sensor matrix in a time sequence, and calculating an average moment arm for each row of the sensor matrix, to reveal a row of sensors whose pressure is distributed farthest from or closest to the reference axis over time. The present invention also provides a method of calculating a percentage of average moment arm row by row to reveal the relative pressure distribution in a row between the sensors sensing pressure closest to and farthest from the reference axis. The present invention further provides a method of calculating a change of average moment arm and a change of percentage of average moment arm over time row by row.

### CROSS-REFERENCE TO RELATED APPLICATION

This application claims priority of Taiwan patent application No. 104136535, filed on Nov. 5, 2015, the content of which is incorporated herein in its entirety by reference.

### BACKGROUND OF THE INVENTION

1. Field of the Invention

The present invention relates to methods of analyzing pressure distribution and particularly relates to methods of analyzing pressure distribution row by row.

2. The Prior Art

In the literature on analysis of pressure distribution over the surface of an object using a pressure sensor matrix to obtain pressure data, the long axis of foot, in its anterior-posterior direction, was aligned parallel to the Y axis of a pressure sensor matrix by Dixon in 2006, with the X axis of the pressure sensor matrix being perpendicular to the Y axis. In addition, the lateral-to-medial deviation of center of pressure (CoP) in the experiment was calculated as the difference between the average moment arm of pressure on the whole sensor matrix with respect to the Y axis, at the moment a heel started to contact the sensor matrix, and the shortest average moment arm of pressure on the whole sensor matrix with respect to the Y axis afterwards. However, this calculation only revealed alteration of the overall pressure distribution on the pressure sensor matrix from the lateral side to the medial side.

The conventional methods of analyzing pressure distribution can only indicate the overall pressure distribution and its change over the surface of an object of interest, because the method is to calculate the average moment arm of pressure on the whole pressure sensor matrix with respect to the Y axis, which cannot represent the pressure distribution over the surface of the fine part of an object, for example, the lateral-medial pressure distribution in the fine part of a heel and its change over time.

Therefore, there is a need for methods of analyzing pressure distribution over the surface of the fine part of an object, which help the specialists in the related professions make the most out of the data collected from pressure sensor matrices and extract detailed information in the change of the pressure distribution in the fine part of an object in the time sequence.

### SUMMARY OF THE INVENTION

For the above purposes, the present invention provides a method of calculating an average moment arm row by row, comprising: measuring pressure distribution in a pressure-exertion process in which an object exerts pressure on a pressure sensor matrix to obtain individual measured pressure values for individual sensors in each row of sensors of the pressure sensor matrix in a time sequence; setting a side edge of the pressure sensor matrix as a reference axis for calculating individual moment arms for individual sensors in each row of sensors with respect to the reference axis; calculating the average moment arm for each row of sensors in the time sequence, wherein the average moment arm is calculated by summing products of the individual measured pressure values for one row of sensors and the individual moment arms for each corresponding sensors, and dividing the summed products by a sum of the individual pressure values for the row of sensors; and identifying the longest or the shortest average moment arm among all the rows of the pressure sensor matrix in the time sequence to reveal the row of sensors whose pressure is distributed farthest from or closest to the reference axis over time.

In one embodiment of the present invention, the time sequence is a time period during which an object exerts pressure on the pressure sensor matrix; one row of sensors at a moment of the time sequence is identified to have the shortest average moment arm among all the rows of the pressure sensor matrix during the pressure-exertion process, which indicates the pressure of the row of sensors is distributed closest to the reference axis at the moment; one row of sensors at a moment of the time sequence is identified to have the longest average moment arm among all the rows of the pressure sensor matrix during the pressure-exertion process, which indicates the pressure of the row of sensors is distributed farthest from the reference axis at the moment.

In another aspect, the present invention also provides a method of calculating a percentage of average moment arm row by row, comprising: measuring pressure distribution in a pressure-exertion process in which an object exerts pressure on a pressure sensor matrix to obtain individual measured pressure values for individual sensors in each row of sensors of the pressure sensor matrix in a time sequence; setting a side edge of the pressure sensor matrix as a reference axis for calculating individual moment arms for individual sensors in each row of sensors with respect to the reference axis; calculating an average moment arm for each row of sensors in the time sequence, wherein the average moment arm is calculated by summing the products of the individual measured pressure values for one row of sensors and the individual moment arms for each corresponding sensors, and dividing the summed products by a sum of the individual pressure values for the row of sensors; identifying the interval between the moment arm for the sensor sensing pressure closest to the reference axis and the moment arm for the sensor sensing pressure farthest from the reference axis for one row of sensors of the pressure sensor matrix at a moment of the time sequence; and calculating the percentage of the average moment arm for the row of sensors within the interval to reveal the relative pressure distribution in the row between the sensors sensing pressure closest to and farthest from the reference axis.

In one embodiment of the present invention, the moment arms for the sensors sensing pressure closest to and farthest from the reference axis indicate the closest and the farthest limits to which the pressure is distributed in the row of sensors with respect to the reference axis; the moment arm for the sensor sensing pressure closest to the reference axis is set at 0% of the interval, the moment arm for the sensor sensing pressure farthest from the reference axis is set at 100% of the interval, and the percentage of the average moment arm for the row of sensors within the interval indicates a proportion in which the pressure is distributed in the row between the sensors sensing pressure closest to and farthest from the reference axis.

In one further aspect, the present invention provides a method of calculating a change of average moment arm, and a change of percentage of average moment arm over time row by row, comprising: measuring pressure distribution in a pressure-exertion process in which an object exerts pressure on a pressure sensor matrix to obtain individual measured pressure values for individual sensors in each row of sensors of the pressure sensor matrix in a time sequence; setting a side edge of the pressure sensor matrix as a reference axis for calculating individual moment arms for individual sensors in each row of sensors with respect to the reference axis; calculating an average moment arm for each row of sensors in the time sequence, wherein the average moment arm is calculated by summing the products of the individual measured pressure values for one row of sensors and the individual moment arms for each corresponding sensors, and dividing the summed products by a sum of the individual pressure values for the row of sensors; identify an interval between the moment arm for the sensor sensing pressure closest to the reference axis and the moment arm for the sensor sensing pressure farthest from the reference axis for a specific row of sensors at a specific moment of the time sequence; and tracing back to the earliest moment at which the specific row of sensors starts to have the same interval, calculating the change of average moment arm and the change of percentage of average moment arm for the specific row within the fixed interval from the earliest moment to the specific moment, to reveal the absolute and relative pressure redistribution in the specific row between the unchanging sensors sensing pressure closest to and farthest from the reference axis over time.

In one embodiment of the present invention, the fixed moment arms for the sensors sensing pressure closest to and farthest from the reference axis indicate the closest and the farthest unchanging limits to which the pressure is redistributed in the specific row of sensors with respect to the reference axis over time; the change of average moment arm for the specific row from the earliest moment to the specific moment indicates the extent in which the pressure in the specific row of sensors is redistributed between the unchanging sensors sensing pressure closest to and farthest from the reference axis over time, whereas the change of percentage of average moment arm indicates a proportion in which the pressure in the specific row of sensors is redistributed between the unchanging sensors sensing pressure closest to and farthest from the reference axis over time.

The methods of analyzing pressure distribution row by row are useful in various investigations of pressure distribution. They help to extract detailed information in the change of pressure distribution in the fine part of an object in the time sequence. They can be applied to analyzing the pressures between foot and insoles, body and orthoses, trunk and cushions, back and backrests, scar and pressure garments, hand and handles, fingertip and keyboards, tires and ground surfaces, to detect subtle change of the pressure distribution in the fine part of an object and to evaluate the effects by various interventions in the time sequence.

The present invention is further explained in the following drawings and examples. It is understood that the examples given below do not limit the scope of the invention, and it will be evident to those skilled in the art that modifications can be made without departing from the scope of the appended claims.

### BRIEF DESCRIPTION OF THE DRAWINGS

The present invention will be apparent to those skilled in the art from the following detailed description of the preferred embodiments, with reference to the attached drawings, in which:

FIGS. 1A-1O show the individual measured pressure values for individual sensors of a pressure sensor matrix in a time sequence during which a right heel starts to exert pressure on the sensor matrix.

### DETAILED DESCRIPTION OF THE PREFERRED EMBODIMENT

The method of calculating an average moment arm row by row provided in the present invention comprises measuring pressure distribution in a pressure-exertion process in which an object exerts pressure on a pressure sensor matrix to obtain individual measured pressure values and individual moment arms for individual sensors in the pressure sensor matrix in a time sequence, calculating average moment arms for each row of pressure sensors from the individual pressure values and the individual moment arms for each row of sensors, and analyzing the pressure distribution in the fine part of an object in the time sequence based on the longest or the shortest average moment arm of all the rows in the time sequence. The present invention also provides methods for further analysis by calculating a percentage of average moment arm row by row, and calculating a change of average moment arm and a change of percentage of average moment arm over time row by row.

### DEFINITION

The term “pressure sensor matrix” used in the present invention refers to a matrix of sensors placed in a pressure measuring instrument which is used for measuring pressure over the surface of an object; it is also termed “sensor matrix” or “matrix”.

The term “fine part” used in the present invention refers to a local area of the surface of an object for analysis; the local area corresponds to any row of pressure sensors in a pressure sensor matrix when an object exerts pressure on the pressure sensor matrix.

### Methods and Materials

### Pressure Distribution Measuring System

The pressure sensor matrix used for pressure measurement is positioned in a pressure measuring instrument HA44 (Novel GmbH, Munich, Germany) with an area of 70.4×70.4 mm. The matrix contains 16×16 pressure sensors, each of which has a size of 4.4×4.4 mm and a measurement range of 10-200 kPa. The matrix of sensors is calibrated by air of known pressure prior to measurement. The software named “Settings” (Novel GmbH, Munich, Germany) is used to set up the internal amplification and offset values for individual sensors in order to reach the highest possible resolution, thus leading to highly accurate calibration data for each sensor. The pressure data is recorded at a sampling rate of 38 frames/s.

### Example 1

### Analysis of Pressure Distribution on Fine Parts of Heels

In the embodiment, the methods of the present invention are exemplified by analyzing pressure distribution on the heel row by row, with steps of this analysis being described as follows.

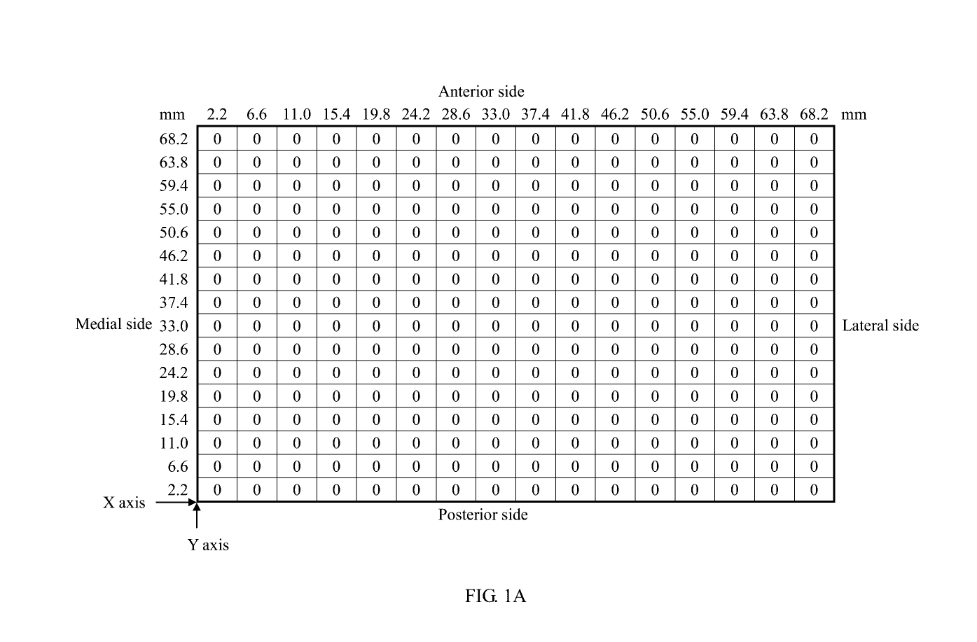

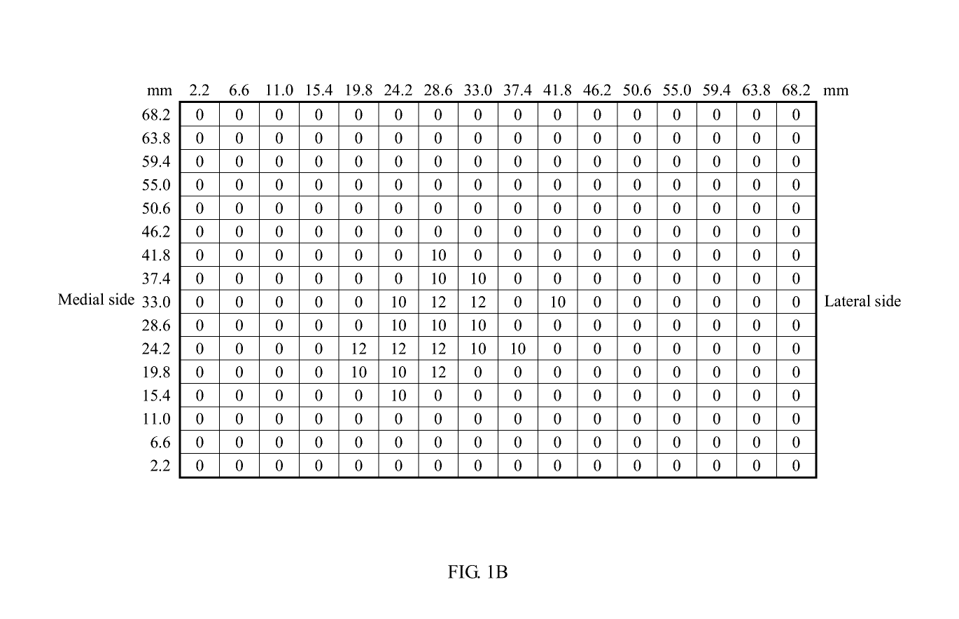

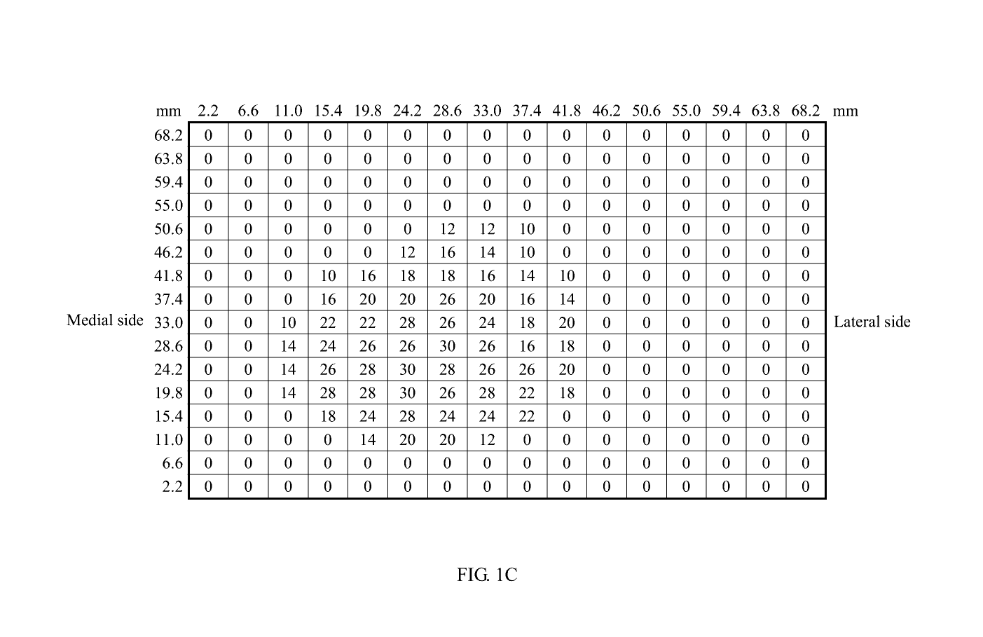

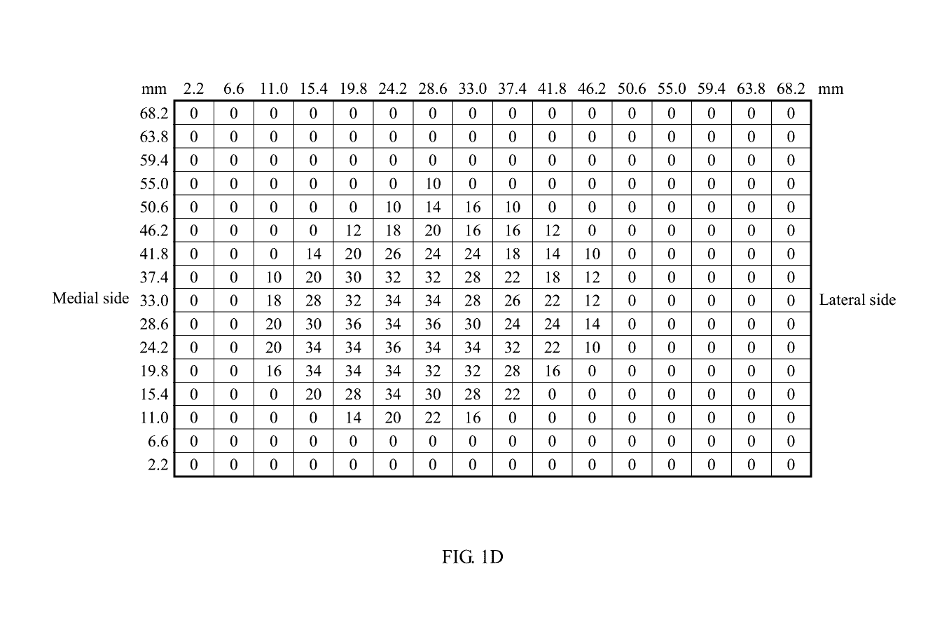

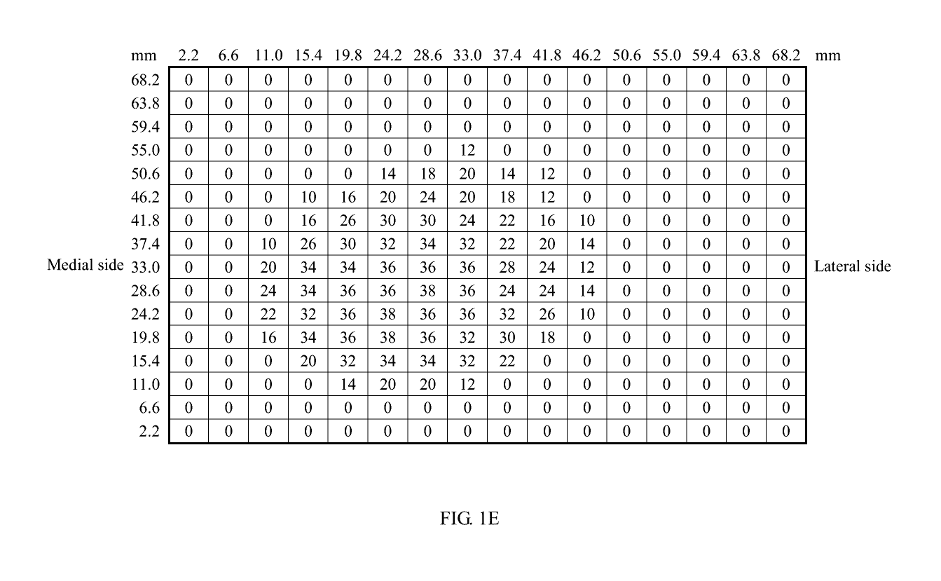

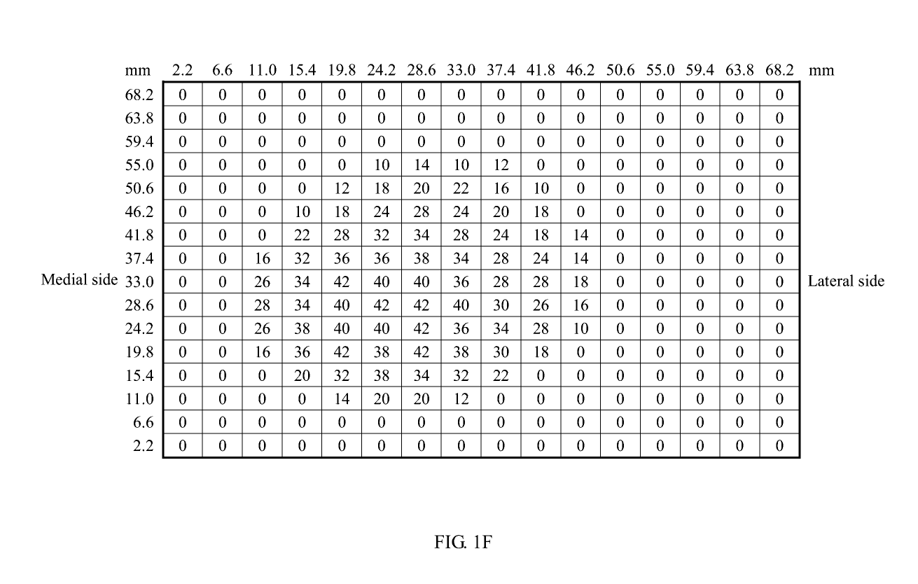

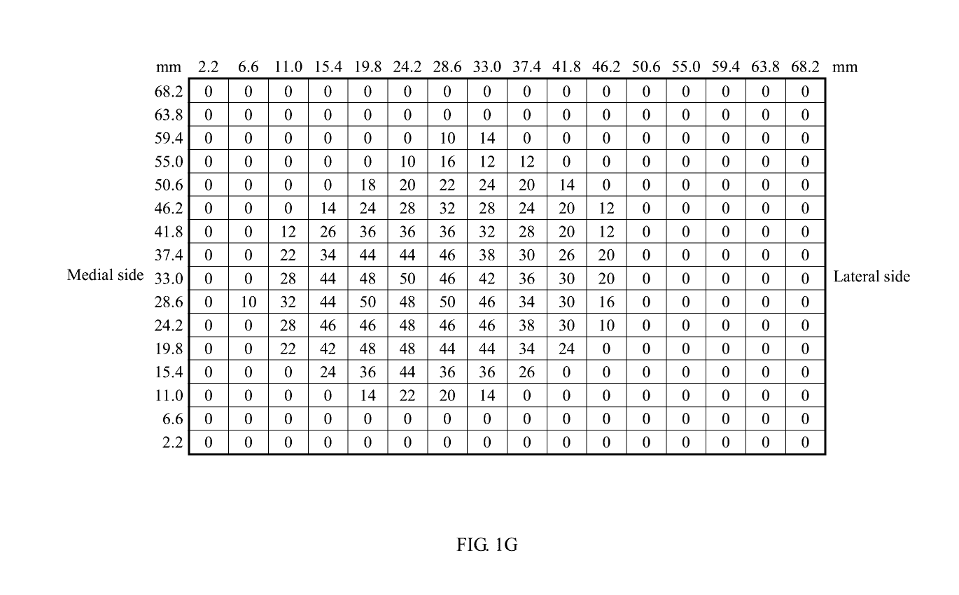

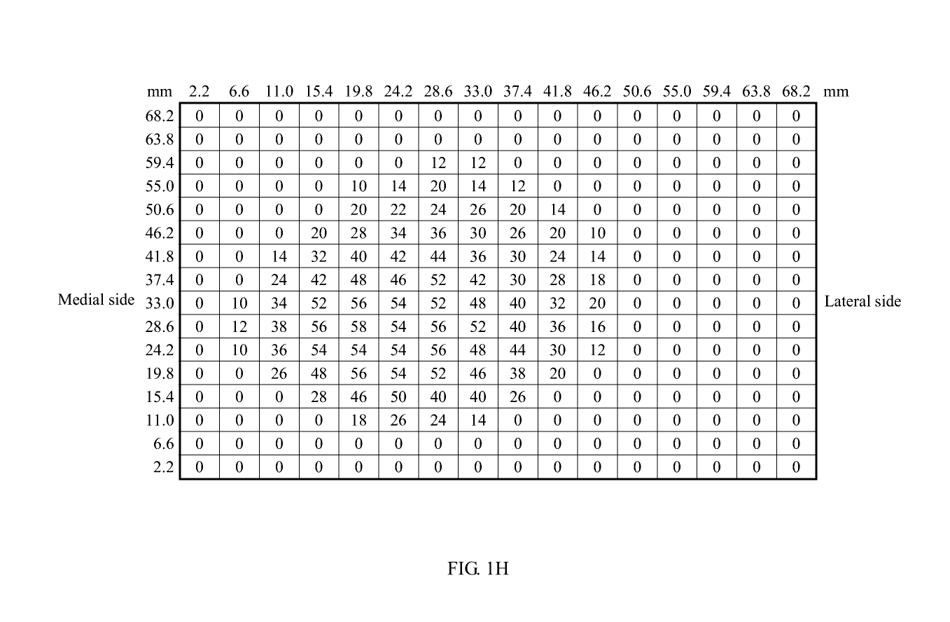

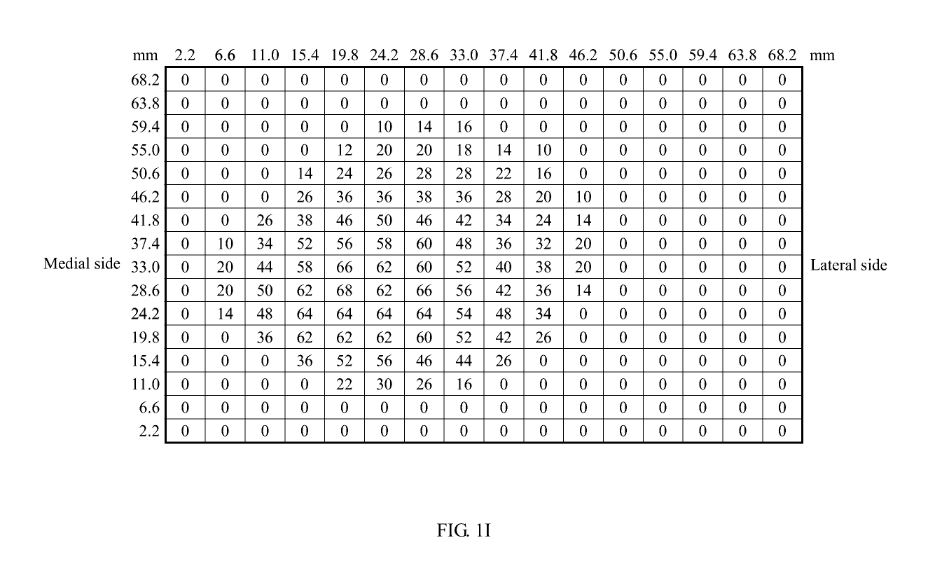

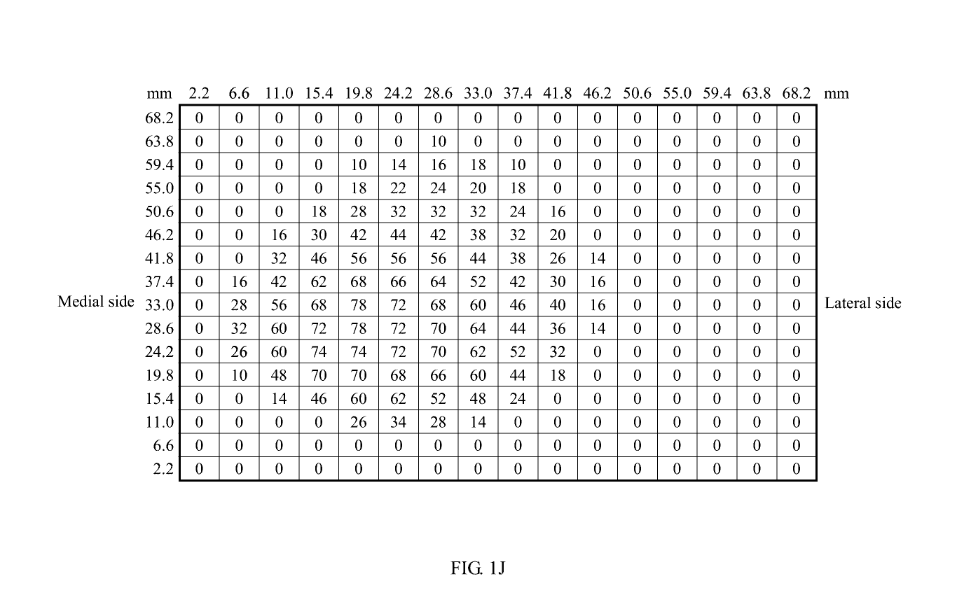

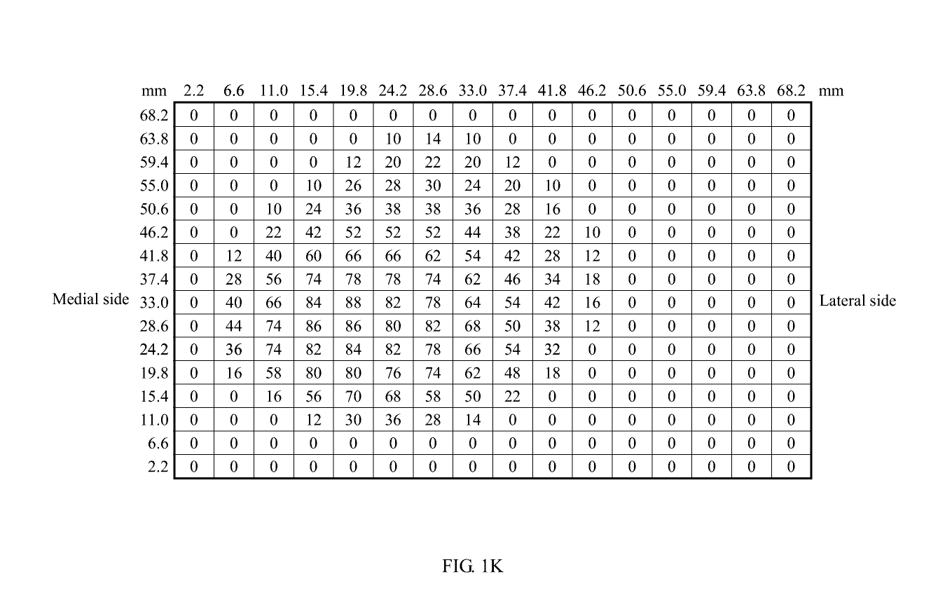

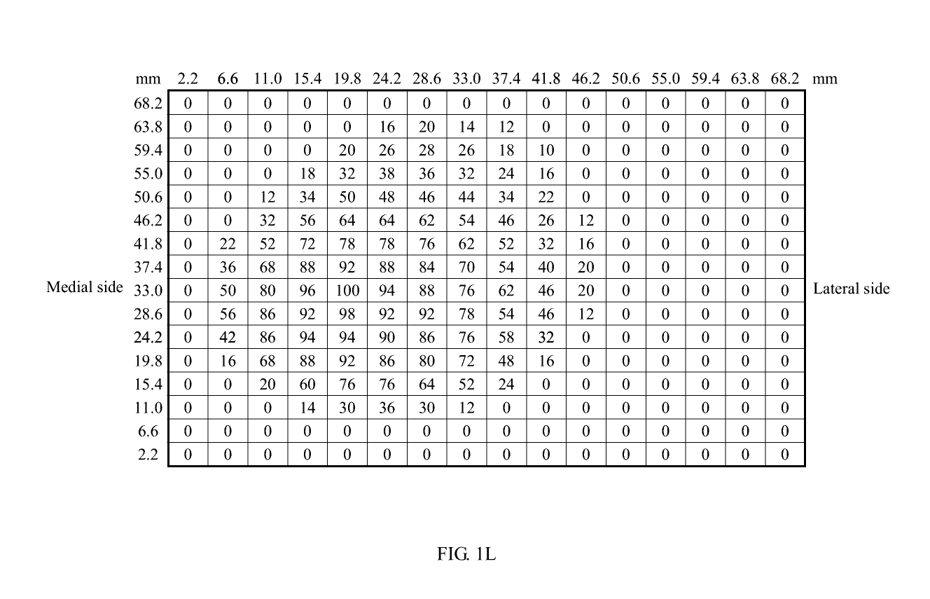

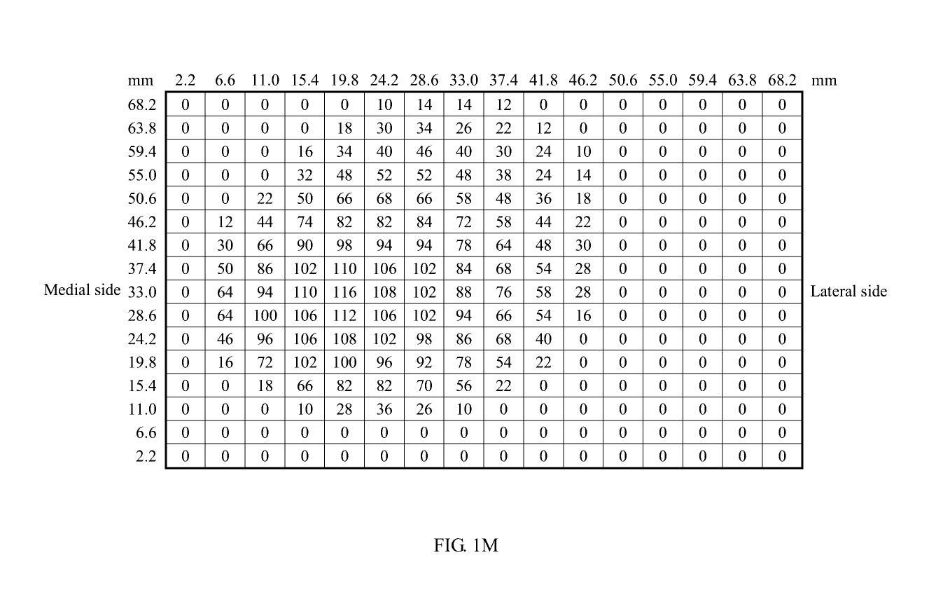

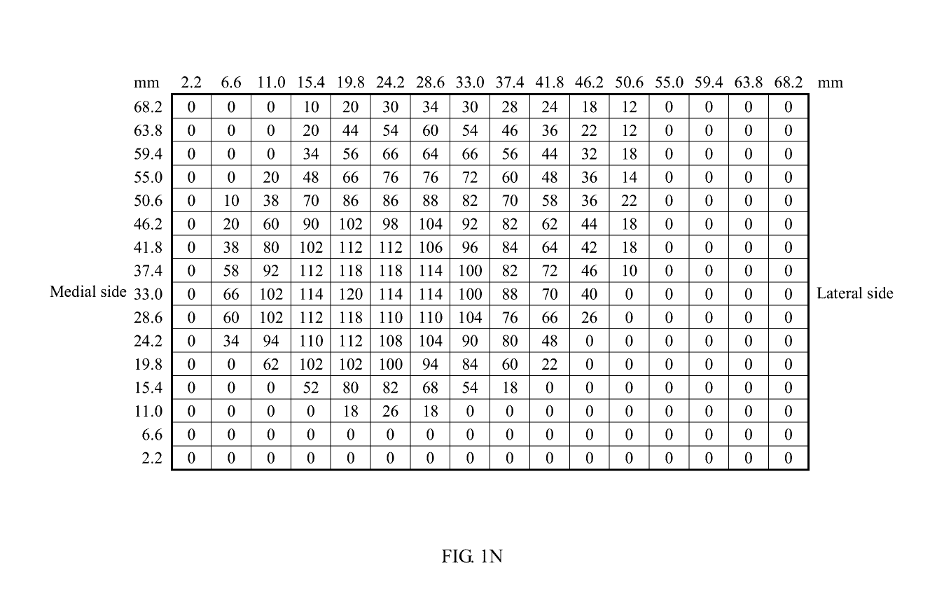

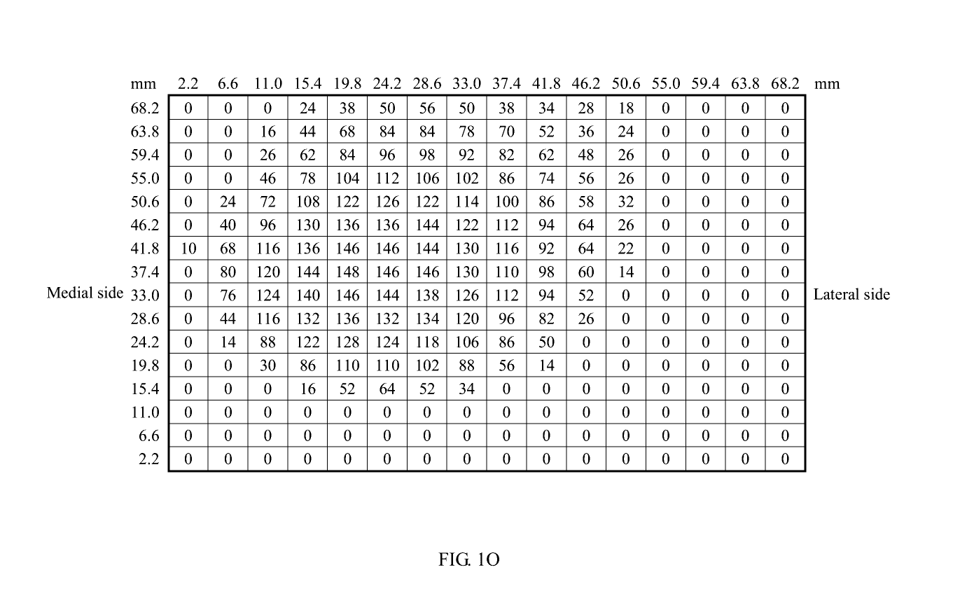

Step 1, a participant aligned the right heel in the air just above the pressure sensor matrix so that the anterior-posterior axis, also the long axis, of the right heel was parallel to a side edge of the sensor matrix. Then, the heel started to exert pressure on the sensor matrix. As shown in FIG. 1A, a side edge of the sensor matrix was defined as the Y axis and used as a reference axis for calculating individual moment arms for individual sensors in the sensor matrix; another side edge of the sensor matrix perpendicular to the Y axis was defined as the X axis. Thus, the aforementioned anterior-posterior axis of the right heel was parallel to the Y axis of the sensor matrix. The Y or X coordinates of individual sensors in the sensor matrix, expressed in mm, represented the distance between the individual sensors and the X axis or the Y axis, respectively. In the embodiment, the top, bottom, left, and right sides of the sensor matrix were denoted as the anterior, posterior, medial, and lateral sides, respectively, corresponding to the directional terms for the right heel in anatomy.

During a time period during which the right heel exerted pressure on the pressure sensor matrix, the pressure data in a time sequence were collected as shown in FIGS. 1A-1O. As shown in FIG. 1A, the individual measured pressure values for all sensors were 0 kPa before the right heel started to exert pressure on the sensor matrix. Starting from FIG. 1B, the number of the sensors on which the right heel exerted pressure and the individual pressure values for those increased gradually. In FIG. 1C, sensors with X coordinates from 11.0 mm to 41.8 mm sensed pressure. In FIG. 1D, sensors with X coordinates from 11.0 mm to 46.2 mm sensed pressure. Starting from FIG. 1Q sensors with X coordinates from 6.6 mm to 46.2 mm sensed pressure. In this pressure-exertion process, the pressure values for individual sensors did not continually increase, but instead varied with fluctuation.

Step 2, from the pressure data shown in FIGS. 1B-1O in the time sequence, the average moment arm for each row of pressure sensors with respect to the Y axis was calculated, showing the pressure distribution for each row of sensors through the course of time. For a row of pressure sensors, the average moment arm is calculated by summing the products of the individual pressure values for the row of pressure sensors and the individual moment arms for each corresponding sensors with respect to the Y axis, and dividing the result by a sum of the individual pressure values for the row of pressure sensors. The calculated average moment arms are shown in TABLE 1, and the formula for calculating the average moment arm is shown below:

Σ(Individual pressure value·X coordinate)/Σ(Individual pressure value)

TABLE 1
Average moment arms for each row of sensors of the pressure sensor matrix shown in FIGS. 1B-1O

| Y coordinate | Average moment arm (mm) | | | | | | | | | | | | | |
|---|---|---|---|---|---|---|---|---|---|---|---|---|---|---|
| (mm) | FIG. 1B | FIG. 1C | FIG. 1D | FIG. 1E | FIG. 1F | FIG. 1G | FIG. 1H | FIG. 1I | FIG. 1J | FIG. 1K | FIG. 1L | FIG. 1M | FIG. 1N | FIG. 1O |
| 68.2 | | | | | | | | | | | | 31.1 | 32.7 | 31.6 |
| 63.8 | | | | | | | | | 28.6 | 28.6 | 30.2 | 29.8 | 31.1 | 30.4 |
| 59.4 | | | | | | 31.2 | 30.8 | 29.3 | 28.9 | 28.6 | 29.5 | 29.6 | 31.1 | 30.0 |
| 55.0 | | | 28.6 | 33.0 | 30.9 | 30.9 | 28.9 | 30.1 | 28.5 | 28.1 | 28.0 | 28.7 | 29.6 | 29.2 |
| 50.6 | | 32.7 | 30.9 | 32.5 | 30.5 | 30.5 | 30.2 | 28.7 | 28.3 | 27.0 | 26.8 | 27.5 | 28.5 | 28.0 |
| 46.2 | | 30.5 | 30.6 | 29.0 | 29.5 | 30.2 | 29.3 | 28.7 | 26.6 | 26.7 | 26.3 | 26.3 | 27.4 | 27.1 |
| 41.8 | 28.6 | 28.3 | 29.6 | 29.3 | 29.3 | 27.9 | 27.8 | 26.9 | 26.4 | 25.3 | 25.0 | 25.4 | 26.3 | 26.0 |
| 37.4 | 30.8 | 28.1 | 28.2 | 28.2 | 27.7 | 27.6 | 27.2 | 26.3 | 25.3 | 24.6 | 24.4 | 24.5 | 25.6 | 25.7 |
| 33.0 | 31.8 | 27.1 | 27.5 | 27.3 | 27.4 | 27.2 | 26.3 | 25.6 | 24.8 | 24.2 | 24.1 | 24.2 | 24.9 | 25.2 |
| 28.6 | 28.6 | 26.3 | 27.4 | 27.0 | 27.2 | 26.3 | 26.0 | 25.1 | 24.3 | 23.7 | 23.5 | 23.7 | 24.5 | 25.0 |
| 24.2 | 28.1 | 26.8 | 27.2 | 27.4 | 27.0 | 26.8 | 25.9 | 24.8 | 24.0 | 23.3 | 23.1 | 23.3 | 24.0 | 24.7 |
| 19.8 | 24.5 | 26.3 | 26.0 | 26.2 | 26.2 | 26.1 | 25.6 | 25.3 | 24.2 | 23.7 | 23.4 | 23.6 | 24.5 | 25.2 |
| 15.4 | 24.2 | 26.7 | 26.5 | 26.5 | 26.5 | 26.4 | 26.0 | 25.7 | 24.6 | 24.1 | 24.0 | 24.0 | 24.8 | 24.9 |
| 11.0 | | 26.2 | 26.6 | 26.2 | 26.2 | 26.3 | 26.0 | 25.9 | 25.5 | 24.3 | 24.1 | 24.1 | 24.2 | |
| 6.6 | | | | | | | | | | | | | | |
| 2.2 | | | | | | | | | | | | | | |

Step 3, among all the rows shown in FIGS. 1A-1O in the time sequence, the row of sensors with Y coordinate of 24.2 mm in FIG. 1L (the Y coordinate highlighted in gray in the figure) has the shortest average moment arm of 23.1 mm with respect to the Y axis, indicating that the row of sensors with Y coordinate of 24.2 mm in FIG. 1L has the most medial pressure distribution among all the rows in the time sequence.

Step 4, in the row with Y coordinate of 24.2 mm in FIG. 1L, the interval between the moment arm for the sensor sensing pressure closest to the Y axis and the moment arm for the sensor sensing pressure farthest from the Y axis were identified. The moment arm with respect the Y axis for the most medial sensor sensing pressure in that row, namely the sensor with X coordinate of 6.6 mm (the sensor highlighted in gray in the figure), was set at 0% of the interval, and the moment arm with respect the Y axis for the most lateral sensor sensing pressure in the row, namely the sensor with X coordinate of 41.8 mm (the sensor highlighted in gray in the figure), was set at 100% of the interval, to indicate the medial and lateral limits of pressure distribution for the row of sensors with Y coordinate of 24.2 mm at the moment of FIG. 1L.

Step 5, based on the average moment arm of 23.1 mm with respect the Y axis for the row of sensors with Y coordinate of 24.2 mm in FIG. 1L, a percentage of the average moment arm for the row with respect to the moment arms of the most medial and most lateral sensors sensing pressure in the row (6.6 mm and 41.8 mm respectively) was calculated as (23.1−6.6)/(41.8−6.6)=46.8%, to indicate the proportion in which the pressure is distributed between the sensors sensing pressure closest to and farthest from the Y axis in the row of sensors with Y coordinate of 24.2 mm.

Step 6, in the pressure-exertion process, tracing back for the row with Y coordinate of 24.2 mm was performed to find the earliest moment at which the row started to have the same medial limit of pressure distribution at X coordinate of 6.6 mm and lateral limit of pressure distribution at X coordinate of 41.8 mm as the row having the shortest average moment arm, and the moment of FIG. 1I was found to be the earliest moment. It indicated that pressure in the row with Y coordinate of 24.2 mm started from the moment of FIG. 1I to be redistributed between the unchanging sensors sensing pressure closest to and farthest from the Y axis, at X coordinates of 6.6 mm and 41.8 mm, to the most medial distribution of pressure in FIG. 1L.

Step 7, since the average moment arm with respect to the Y axis for the row of sensors with Y coordinate of 24.2 mm in FIG. 1I was 24.8 mm, and the shortest average moment arm with respect to the Y axis for the row of sensors with Y coordinate of 24.2 mm in FIG. 1L was 23.1 mm, the difference between the above-mentioned two average moment arms was 1.7 mm. It indicated the extent in which the pressure in the row of sensors with Y coordinate of 24.2 mm is redistributed to the most medial distribution of pressure between the unchanging medial and lateral limits of pressure distribution from FIG. 1I to FIG. 1L.

Step 8, the difference of 1.7 mm between the above-mentioned two average moment arms was further divided by the interval of 35.2 mm between the moment arms for the most medial (X coordinate of 6.6 mm) and most lateral (X coordinate of 41.8 mm) sensors sensing pressure in the row with Y coordinate of 24.2 mm to give 4.9%, to indicate the proportion in which the pressure in the row of sensors with Y coordinate of 24.2 mm is redistributed to the most medial distribution of pressure between the unchanging medial and lateral limits of pressure distribution from FIG. 1I to FIG. 1L. The value of 4.9% could also be calculated as the difference between the percentages of the average moment arms for the row with Y coordinate of 24.2 mm in FIG. 1I (51.7%) and in FIG. 1L (46.8%). The difference between the percentage of 51.7% in FIG. 1I and the percentage of 49.3% in FIG. 1J was 2.4%; the difference between the percentage of 49.3% in FIG. 1J and the percentage of 47.6% in FIG. 1K was 1.7%; the difference between the percentage of 47.6% in FIG. 1K and the percentage of 46.8% in FIG. 1L was 0.8%, indicating that the proportion of pressure redistributed was largest at the beginning of the process and gradually decreased thereafter.

In view of the above embodiment, the methods of analyzing pressure distribution row by row provided in the present invention are different from the conventional method of calculating average moment arm of matrix. For example, by the conventional method, the average moment arm for the whole matrix in FIG. 1L is 24.6 mm, and the average moment arm for the whole matrix in FIG. 1I is 26.1 mm. However, by the present invention, the average moment arm for each row of sensors of a pressure sensor matrix with respect to the Y axis of the matrix indicates the medial-lateral pressure distribution in each fine part of an object, and the shortest or longest average moment arm of all the rows of pressure sensors with respect to the Y axis of the matrix in a time sequence indicates the most medial or most lateral distribution of pressure in the fine part of an object. For example, the shortest average moment arm of 23.1 mm of all the rows appeared in the row with Y coordinate of 24.2 mm in FIG. 1L. Moreover, the methods of the present invention use the moment arm for the most medial pressure sensor sensing pressure in one row of pressure sensors with respect to the Y axis to indicate the medial limit of pressure distribution over the surface of the fine part of an object, use the moment arm for the most lateral pressure sensor sensing pressure in one row of pressure sensors with respect to the Y axis to indicate the lateral limit of pressure distribution over the surface of the fine part of an object, and calculate a percentage of the average moment arm for one row of pressure sensors relative to the moment arms for the most medial sensor, at 0% of the interval sensing pressure, and most lateral sensor, at 100% of the interval sensing pressure, to indicate the proportion of pressure distributed over the surface of the fine part of an object. For example, the percentage of average moment arm for the row having the shortest average moment arm of all the rows in FIG. 1L was 46.8%, and it can be compared to the percentages of average moment arms in the fine parts of other objects with different medial and lateral limits of pressure distribution. In TABLE 2, comparison between the conventional method and the present invention in analyzing pressure distribution in the heel for participants with or without forefoot varus (abbreviated as FV) reveals significantly lower percentage of average moment arm of the row with the shortest average moment arm in participants with FV than those without FV, which demonstrates calculating the percentage of average moment arm row by row can detect more medial distribution of pressure in the fine part of the heel for participants with FV, while the percentage of average moment arm for the whole matrix cannot be calculated using the conventional method.

TABLE 2
Comparison of methods of analyzing pressure
distribution in participants with and without FV

| | Participants | Participants | |
|---|---|---|---|
| | without FV | with FV | p value |
| Percentage of average moment | 47.8 ± 0.8 | 45.9 ± 1.3 | 0.0005 |
| arm of row (%) | | | |
| Percentage of average moment | N/A | N/A | |
| arm of matrix (%) | | | |
| Change over time: | | | |
| Average moment arm of row | 1.1 ± 0.6 | 1.6 ± 0.3 | 0.049 |
| (mm) | | | |
| Average moment arm of | 1.1 ± 0.6 | 1.4 ± 0.6 | 0.36 |
| matrix (mm) | | | |
| Percentage of average moment | 2.9 ± 1.4 | 4.2 ± 1.1 | 0.023 |
| arm of row (%) | | | |
| Percentage of average moment | N/A | N/A | |
| arm of matrix (%) | | | |

The percentage of average moment arm of row, the change of average moment arm of row, and the change of percentage of average moment arm of row refer to the row with the shortest average moment arm in the time sequence.

After an object exerts pressure on the pressure sensor matrix, the medial and lateral limits of pressure distribution for the row having the shortest or longest average moment arm continue to change, until the earliest moment when the row just starts to have the same medial and lateral limits of pressure distribution as when the row will have the shortest or longest average moment arm. Afterwards, the row will keep the same medial and lateral limits of pressure distribution until it has the shortest or longest average moment arm. For example, the medial and lateral limits of pressure distribution for the row of sensors with Y coordinate of 24.2 mm continued to change from FIG. 1B to FIG. 1H, until FIG. 1I when it just started to have the same medial limit of pressure distribution at X coordinate of 6.6 mm and lateral limit of pressure distribution at X coordinate of 41.8 mm as FIG. 1L when the row will have the shortest average moment arm. Afterwards, the row with Y coordinate of 24.2 mm continued to have the same medial and lateral limits of pressure distribution until FIG. 1L. From FIG. 1I to FIG. 1L, the change of average moment arm of the matrix from 26.1 mm to 24.6 mm was 1.5 mm, less than the change of average moment arm of the row with Y coordinate of 24.2 mm and having the shortest average moment arm, which was 1.7 mm from 24.8 mm to 23.1 mm. In TABLE 2, the change of average moment arm of the matrix was not significantly different between participants with and without FV (p=0.36), while the change of average moment arm of the row with the shortest average moment arm was significantly different between participants with and without FV (p=0.049), which demonstrates calculating the change of average moment arm row by row can detect increased redistribution of pressure in the fine part of the heel for participants with FV, while the conventional method of calculating the change of average moment arm of matrix cannot. From FIG. 1I to FIG. 1L, the change of percentage of average moment arm row by row was calculated as dividing the change of average moment arm of 1.7 mm by the fixed interval of 35.2 mm, which equaled to 4.9%. TABLE 2 also demonstrates that calculating the change of percentage of average moment arm row by row can detect increased proportion of pressure redistributed, with even greater statistical significance (p=0.023) than calculating the change of average moment arm row by row (p=0.049), in the fine part of the heel for participants with FV, while the change of percentage of average moment arm of matrix cannot be calculated using the conventional method.

The present invention detected decreased percentage of average moment arm, increased change of average moment arm, and increased change of percentage of average moment arm in the row with the shortest average moment arm for participants with FV (TABLE 2), and may be applied to other clinical conditions where the conventional method cannot detect significant differences in the distribution or redistribution of pressure. The row with the shortest average moment arm represents a common anatomic feature with functional variation in the calcaneal tuberosity of each rearfoot, although it may be a different row in different feet. It corresponds to the most everted part of the rearfoot where the pressure is distributed most medially after initial heel contact, and is approximately in the same position of each rearfoot.

The percentage of average moment arm of the row with the shortest average moment arm indicates the relative position of the average moment arm between the medial and lateral borders of pressure distribution in the most everted part of the rearfoot, and therefore can be compared among different feet with different sizes at different time. When the row with the shortest average moment arm just starts to have the same medial and lateral limits of pressure distribution as when it will have the shortest average moment arm, the percentage of average moment arm is around 50%, indicating that the average moment arm is approximately at the midpoint between the medial and lateral borders of pressure distribution. The change of percentage of average moment arm indicates the proportion of pressure redistributed in the most everted part of the rearfoot changes from 50% at start to the most medial distribution of pressure.

The present invention may be applied to clinical conditions other than FV, where increased rearfoot eversion after initial heel contact has been controversial: it may contribute further evidence to whether increased rearfoot eversion after initial heel contact is associated with patellofemoral pain syndrome. It may also be applied to clinical conditions where decreased rearfoot eversion after initial heel contact has been inconclusive: it may contribute to the prospective study of decreased rearfoot eversion after initial heel contact in the development of iliotibial band syndrome. It not only provides objective evidence of the functional adaptive mechanisms in FV, but also the impetus for further research and development into the design of foot orthoses and footwear: it may be used to evaluate the treatment of abnormal biomechanics in the rearfoot after initial heel contact, where the use of kinematic and kinetic measurements is limited by the hindrance of shoes and orthoses to directly approaching the plantar surface of the rearfoot.

In conclusion, the methods of analyzing pressure distribution row by row provided in the present invention are applicable to various investigations for pressure distribution and redistribution over the surface of the fine part of an object, including analysis and product development related to pressure distribution and redistribution on any interface of the fine part over time, such as the interfaces between trunk and cushions, back and backrests, scar and pressure garments, hand and handles, fingertip and keyboards, tires and ground surfaces, but not limited to evaluation, development, and manufacture of various lower limb orthoses, such as footwear, shoes, insoles. One example of application of the methods of the present invention may be a pressure measuring system linked to a mobile intelligent device and continually recording and analyzing pressure distribution and redistribution on an interface between a body surface and the environment, which instantly provides messages of abnormal pressure distribution and redistribution, forewarns the medical personnel to intervene in time, and effectively prevents complications such as skin ulcers, pressure ulcers, ischemia, necrosis, and neuropathy, to improve medical quality and lower burden for medical personnel.

What is claimed is:

1. A method of calculating an average moment arm row by row, comprising:
measuring pressure distribution in a pressure-exertion process in which an object exerts pressure on a pressure sensor matrix to obtain individual measured pressure values for individual sensors in each row of sensors of the pressure sensor matrix in a time sequence;
setting a side edge of the pressure sensor matrix as a reference axis for calculating individual moment arms for individual sensors in each row of sensors with respect to the reference axis;
calculating the average moment arm for each row of sensors in the time sequence, wherein the average moment arm is calculated by summing products of the individual measured pressure values for one row of sensors and the individual moment arms for each corresponding sensors, and dividing the summed products by a sum of the individual pressure values for the row of sensors; and
identifying the longest or the shortest average moment arm among all the rows of the pressure sensor matrix in the time sequence to reveal the row of sensors whose pressure is distributed farthest from or closest to the reference axis over time.

2. The method of claim 1, wherein the time sequence is a time period during which the object exerts pressure on the pressure sensor matrix.

3. The method of claim 1, wherein one row of sensors at a moment of the time sequence is identified to have the shortest average moment arm among all the rows of the pressure sensor matrix during the pressure-exertion process, which indicates the pressure of the row of sensors is distributed closest to the reference axis at the moment.

4. The method of claim 1, wherein one row of sensors at a moment of the time sequence is identified to have the longest average moment arm among all the rows of the pressure sensor matrix during the pressure-exertion process, which indicates the pressure of the row of sensors is distributed farthest from the reference axis at the moment.

5. A method of calculating a percentage of average moment arm row by row, comprising:
measuring pressure distribution in a pressure-exertion process in which an object exerts pressure on a pressure sensor matrix to obtain individual measured pressure values for individual sensors in each row of sensors of the pressure sensor matrix in a time sequence;
setting a side edge of the pressure sensor matrix as a reference axis for calculating individual moment arms for individual sensors in each row of sensors with respect to the reference axis;
calculating an average moment arm for each row of sensors in the time sequence, wherein the average moment arm is calculated by summing products of the individual measured pressure values for one row of sensors and the individual moment arms for each corresponding sensors, and dividing the summed products by a sum of the individual pressure values for the row of sensors;
identifying an interval between the moment arm for the sensor sensing pressure closest to the reference axis and the moment arm for the sensor sensing pressure farthest from the reference axis for one row of sensors of the pressure sensor matrix at a moment of the time sequence; and
calculating a percentage of the average moment arm for the row of sensors within the interval to reveal the relative pressure distribution in the row between the sensors sensing pressure closest to and farthest from the reference axis.

6. The method of claim 5, wherein the moment arms for the sensors sensing pressure closest to and farthest from the reference axis indicate the closest and the farthest limits to which the pressure is distributed in the row of sensors with respect to the reference axis.

7. The method of claim 5, wherein the moment arm for the sensor sensing pressure closest to the reference axis is set at 0% of the interval, the moment arm for the sensor sensing pressure farthest from the reference axis is set at 100% of the interval, and the percentage of the average moment arm for the row of sensors within the interval indicates a proportion in which the pressure is distributed in the row between the sensors sensing pressure closest to and farthest from the reference axis.

8. A method of calculating a change of average moment arm and a change of percentage of average moment arm over time row by row, comprising:
measuring pressure distribution in a pressure-exertion process in which an object exerts pressure on a pressure sensor matrix to obtain individual measured pressure values for individual sensors in each row of sensors of the pressure sensor matrix in a time sequence;
setting a side edge of the pressure sensor matrix as a reference axis for calculating individual moment arms for individual sensors in each row of sensors with respect to the reference axis;
calculating an average moment arm for each row of sensors in the time sequence, wherein the average moment arm is calculated by summing products of the individual measured pressure values for one row of sensors and the individual moment arms for each corresponding sensors, and dividing the summed products by a sum of the individual pressure values for the row of sensors;
identify an interval between the moment arm for the sensor sensing pressure closest to the reference axis and the moment arm for the sensor sensing pressure farthest from the reference axis for a specific row of sensors at a specific moment of the time sequence; and
tracing back to the earliest moment at which the specific row of sensors starts to have the same interval, calculating the change of average moment arm and the change of percentage of average moment arm for the specific row within the fixed interval from the earliest moment to the specific moment, to reveal the absolute and relative pressure redistribution in the specific row between the unchanging sensors sensing pressure closest to and farthest from the reference axis over time.

9. The method of claim 8, wherein the fixed moment arms for the sensors sensing pressure closest to and farthest from the reference axis indicate the closest and the farthest unchanging limits to which the pressure is redistributed in the specific row of sensors with respect to the reference axis over time.

10. The method of claim 8, wherein the change of average moment arm for the specific row from the earliest moment to the specific moment indicates the extent in which the pressure in the specific row of sensors is redistributed between the unchanging sensors sensing pressure closest to and farthest from the reference axis over time.

11. The method of claim 8, wherein the change of percentage of average moment arm indicates a proportion in which the pressure in the specific row of sensors is redistributed between the unchanging sensors sensing pressure closest to and farthest from the reference axis over time.
